(19) United States
(12) Patent Application Publication
(10) Pub. No.: US 2023/0258563 A1
(43) Pub. Date: Aug. 17, 2023

(54) DETECTION OF VOLATILES

(71) Applicant: ISOBIONICS B.V., Geleen (NL)

(72) Inventors: Georg Friedrich LENTZEN, Geleen (NL); Elena MELILLO, Geleen (NL); Harald PICHLER, Graz (AT); Sandra MOSER, Graz (AT); Tamara WRIESSNEGGER, Graz (AT); Stefan SPIRK, Graz (AT); David REISHOFER, Graz (AT); Valentin STEINWENDER, Graz (AT); Werner SCHLEMMER, Graz (AT); Zan CAF-FELDIN, Malecnik (SI)

(21) Appl. No.: 17/630,217

(22) PCT Filed: Jul. 24, 2020
(86) PCT No.: PCT/EP2020/070996

§ 371 Date: Jan. 26, 2022

(30) Foreign Application Priority Data
Jul. 26, 2019 (NL) 2023580

(51) Int. Cl. G01N 21/64

(52) U.S. Cl. CPC G01N 21/6428; G01N 2021/6439; G01N 2500/10

(57) ABSTRACT

The present invention relates to a sensing composition for detecting a volatile organic compound in its gas phase, comprising 1) a silylated cellulose selected from the group of trialkylsilyl cellulose, triarylsilyl cellulose and alkylarylsilyl cellulose; and 2) a fluorescent dye. The detection of a volatile with this sensing composition comprises placing the sensing composition (optionally present as a layer on a support) in the vicinity of a potential source of a volatile and analyzing the sensing composition to determine whether a volatile of the potential source has reached the sensing composition. This detection can be performed in a quantitative manner by means of spectrophotometric analysis, and/or by image analysis of the sensing composition. The invention is particularly useful for application in high throughput screening.

### CROSS-REFERENCE TO RELATED APPLICATIONS

This application is a national stage application (under 35 U.S.C. § 371) of PCT/EP2020/070996, filed Jul. 24, 2020, which claims benefit of Netherlands Application No. 2023580, filed Jul. 26, 2019, both of which are incorporated herein by reference in their entirety.

The present invention relates to a sensing composition for detecting a volatile and to a support comprising such composition for detecting a volatile. The invention further relates to a method for preparing such support. The invention further relates to uses of such sensing composition or support for detecting a volatile from a potential source as well as to a method of detecting a volatile from a potential source by allowing the volatile to interact with the sensing composition and determining whether the volatile is present in/on the sensing composition, and optionally quantifying the amount of the interacting volatile.

### BACKGROUND

Volatile organic compounds (often abbreviated as “volatiles”) play an important role as signal molecules, deterrents and attractants, which gives them a large potential for application in the field of pharmaceuticals and the field of flavors and fragrances. Other important applications are in the field of plant protection products (e.g. pesticides) and biofuels (Gounaris, 2010). Detection of volatile organic compounds can be desirable for several reasons, e.g. to assess ripening of fruit or vegetables or to detect and quantify the production of volatiles by animal, plant or microbial cells.

The ongoing discovery and identification of genomes of organisms that produce volatile organic compounds, in particular terpenes and terpenoids, allows for metabolic engineering approaches to make virtually any terpene/terpenoid in genetically amenable microbial hosts. Such microbial production methods are an attractive alternative to conventional crop growth and product isolation therefrom. By definition, a terpene is a hydrocarbon (no heteroatoms), while a terpenoid is a terpene with a functional group comprising a heteroatom such as an oxygen containing functional group (there may be also be a plurality of functional groups in a terpenoid, for example two or three). In the remainder of this description, however, for the sake of conciseness, the term terpene is also encompassed by the term terpenoid (unless both terms occur together to make a distinction between both terms).

To overcome limitations in the volatile organic compound production in microbes and to optimize the process, further genetic modification is often necessary. However, due to the complexity of terpene/terpenoid synthase reaction mechanisms and sophisticated reaction cascades in whole cell approaches, rational enzyme and cell engineering strategies often have limited success. Hence, the generation and testing of large libraries of producer strain variants, e.g. by directed evolution and random mutagenesis, presents a powerful tool. However, due to the hydrophobic and volatile characteristics of many terpenoids, simple high-throughput screening assays are difficult to establish. As terpenoids, with the exception of carotenoids, are colorless, their direct and visual detection is not possible. Most terpenoids do also not show any suitable UV absorption. Many approaches for screening therefore still rely on low-throughput gas-chromatography based methods for product identification and quantification. Therefore, an easy and scalable high-throughput screening assay for volatile organic compounds is desired.

The sesquiterpene valencene, naturally occurring in citrus fruits such as oranges (Hunter and Brogden, 1965), is used as flavor ingredient as well as a precursor for the preparation of nootkatone, a highly sought-after terpenoid occurring in grapefruit (Wilson and Shaw, 1978). Microbial production of valencene and nootkatone has been successfully established with both prokaryotic and eukaryotic hosts (Girhard et al., 2009), (Beekwilder et al., 2014), (Wriessnegger et al., 2014). Investigations to the use of Rhodobacter sphaeroides as a host were however hampered by the lack of a proper method to detect the intended sesquiterpenoid (such as valencene and nootkatone), because R. sphaeroides is a natural producer of carotenoids (Lang et al., 1995). Conventional detection methods that rely on the presence of Nile Red in the culture (Ubersax and Frenz, 2012) may suffer from a strong background signal due to the interaction of Nile Red with the carotenoids of R. sphaeroides, which impedes accurate measurement of the signal due to the interaction of valencene with Nile Red. This poses another challenge in the development of high-throughput screening assays.

Nile Red has not been used successfully employed for culture measurements so far, albeit it has been used for other purposes e.g. as a model drug covalently bound to an alkoxysilane hydroxypropylmethyl cellulose matrix for drug co-encapsulation studies (Zayed et al; Int. Journal of Pharmaceutics 532 (2017) 790-801)

Nevertheless, a few approaches for the detection of terpenoids have been described:
measuring prenyl phosphate precursor consumption (Furubayashi et al., 2014; Withers et al., 2007);
measuring the protective properties of terpenoids against detergents (Kirby et al., 2014);
detecting by-products that give a colorimetric read-out (Lauchli et al., 2013; Vardakou et al., 2014).

One major disadvantage of all these assays is that they do not give a direct read-out of terpenoid biosynthesis. Additionally, the assays based on colored by-products require the generation of cell lysates, which scales down throughput and might influence enzyme activities. So far, the most promising approach for direct detection of terpenoids is based on the addition of fluorescent dyes, for example Nile Red and BODIPY, to terpenoid-producing cultures. Subsequent spectrophotometric analysis allows quantification of terpenoids bound by those dyes. However, cellular background signals can negatively interact with the intended signal. Another disadvantage is that it cannot be applied to organisms with endogenous production of terpenoids or other dye-binding, hydrophobic compounds like polyhydroxybutyrate (Lagares Jr. and Valverde, 2017).

### SUMMARY OF THE INVENTION

The invention disclosed here provides a novel assay for the direct detection of volatile organic compounds, in particular volatile hydrophobic compounds, without any cellular background signal, allowing an in vivo screening of terpenoid-producing microbes during cultivation in 96-well plates. The assay is based on the volatile nature of terpenoids and is applicable for diverse microbial production hosts and terpenoids.

A layer of a sensing composition comprising silylated cellulose and a fluorescent dye provided on a support is employed for the detection. When the sensing composition is exposed to a volatile organic compound, then the volatile organic compound interacts with the sensing composition, thereby causing a color shift in the visible and UV range, and/or a change in fluorescence. These effects are visible even to the naked eye and can be analyzed semi-quantitatively in an automated fashion using a standard flatbed scanner or a plate-reader. Quantitative analysis can be performed by image analysis and/or by fluorescence spectroscopy and other spectrophotometric techniques such as UV-visible absorbance (colorimetry), phosphorescence, chemiluminescence, infrared absorbance and Raman spectroscopy.

This assay has successfully been applied to 96-well microtiter plate cultivation of microbial terpenoid-producing cells by incubating the support with the sensing composition on the wells. The interaction of volatile compounds with the sensing composition resulted in a clearly visible color shift and/or a change in the fluorescence intensity, while quantitative analysis and semi-quantitative analysis could also be performed on the supported sensing composition.

The assay has further been applied for the analysis of a collection of Rhodobacter sphaeroides strains expressing diverse variants of valencene synthase (ValS) from Callitropsis nootkatensis (Beekwilder et al., 2013) to yield different levels of (+)-valencene. The applicability of the assay was also demonstrated for a eukaryotic terpenoid production host, the methylotrophic yeast Pichia pastoris with clearly reduced terpenoid levels compared to the bacterial host.

In one aspect the invention provides a sensing composition for detecting a volatile organic compound, comprising
a silylated cellulose selected from the group of trialkylsilyl cellulose, triarylsilyl cellulose and alkylarylsilyl cellulose; and
a fluorescent dye.

Examples of such fluorescent dyes are, e.g., NBD, Dansyl, DASPMI, Prodan, Dapoxyl, 4-DMAP, 4-amino-1,8-naphthalimide derivatives, azo dyes such as Sudan dyes (e.g. Sudan I and Sudan II), Reichardt's dye, Oil Red O and Nile Red, preferably Oil Red O or Nile Red. The inventors have surprisingly found that a support comprising a layer of such sensing composition is especially useful in high throughput screening of volatile compounds, such as terpenoids. Until now, it was not possible to reliably and specifically determine without delay (i.e. directly) the presence and concentration of volatile compounds produced by e.g. bacterial strains.

In another aspect, the invention provides a support comprising the sensing composition (in particular a layer thereof), wherein the layer is present on a surface of the support. The support may comprise a material selected from the group of glass, silicon, a polyamide, a polyester (in particular polyethylene terephthalate), and polyolefin (in particular polyethylene or polypropylene).

In yet another aspect, the invention provides a method for producing the support comprising a layer of such sensing composition, the method comprising:
preparing a solution of the silylated cellulose and the fluorescent dye in an organic solvent; then
preparing a film of the solution onto a surface of the support; then
allowing the organic solvent to evaporate so that a layer of the sensing composition is formed on the surface of the support.

In yet another aspect, the invention provides a use of such sensing composition, in particular a support comprising such sensing composition, for the detection of a volatile, in particular for the detection of a volatile terpenoid. Such use comprises placing the sensing composition in the vicinity of the source so that if a volatile is formed, the volatile will reach the sensing composition in an amount that is sufficient for detecting the volatile.

As mentioned above, the support is in particular useful for high throughput screening, e.g., when screening multiple strains on the production of desirable (or undesirable) volatile production.

In a final aspect, the invention provides a method for detecting a volatile, the method comprising: providing a support comprising the sensing composition, providing a potential source of a volatile that is placed such that it allows the eventual volatile to contact the sensing composition, and determining whether a volatile is present in the potential source. Optionally, the amount of a volatile present in the source is quantified by measurement of the fluorescence of the sensing composition or by image analysis of the support with the sensing composition. Using such method of the invention, the inventors were able to detect and quantify volatiles added to medium or water, or produced in cell cultures.

### BRIEF DESCRIPTION OF THE FIGURES

FIG. 1 displays an exploded view of a screening set-up comprising a 96-well plate that is covered with a support comprising the sensing composition of the invention.

FIG. 2 displays a scan of a layer of a sensing composition of the invention containing 0.05% Nile Red after incubation for 5 h on the 96-well plate with cultivated R. sphaeroides strains. A grid overlay is used to mark the wells for densitometric analysis. Numbers represent the different strains and controls tested; R denotes standards included.

FIG. 3 displays the densitometric analysis of the scan of FIG. 2 using the program ImageJ.

FIG. 4 displays the results of the GC-FID analysis of different strains of the cultivated R. sphaeroides, the different strains representing the valencene production levels from 29 to 34 h after start as well as during the entire 72 h of cultivation.

FIG. 5 displays the GC-FID analysis of valencene levels in n-dodecane phase after cultivation of background strain #100 and improved strain #116 identified during screening. The y-axis displays the relative titre.

FIG. 6 displays the ImageJ evaluation of a layer of a composition of the invention used for screening of P. pastoris wild type (PpWT) and valencene synthase-expressing (PpValS) strains.

FIG. 7 displays a further scan of a layer of a sensing composition of the invention containing 0.05% Nile Red after incubation for 5 h on another 96-well plate with cultivated R. sphaeroides strains. The whiter a cell appears on the scan, the more productive with respect to the detected volatiles was the strain in that well of the 96-well plate and vice versa.

### DETAILED DESCRIPTION OF THE INVENTION

For the detection of volatile organic compounds in their gas phase, it appeared advantageous to combine the appropriate fluorescent dye (i.e. appropriate for detecting the intended volatile organic compound) with a particular auxiliary material that interacts with the sensing composition, in particular by becoming adsorbed to it. It is contemplated that the analyte so accumulates in the vicinity of the fluorescent dye and so increases the number of analyte molecules that interact with the fluorescent dye.

A composition of the invention provides such combination in that the auxiliary material is a silylated cellulose selected from the group of trialkylsilyl cellulose, triarylsilyl cellulose and alkylarylsilyl cellulose. An alkylarylsilyl cellulose is meant to include a diarylalkylsilyl cellulose as well as a dialkylarylsilyl cellulose.

The trialkylsilyl cellulose, triarylsilyl cellulose and alkylarylsilyl cellulose may in principle comprise any alkyl and/or aryl group. Usually, however, the three alkyl and/or aryl groups in the silylated moiety together comprise 20 carbon atoms or less. An alkyl group in the silylated cellulose usually comprises 1-6 carbon atoms and an aryl group usually 4-8 carbon atoms.

For example, the silylated cellulose is a trialkylsilyl cellulose selected from the group of trimethylsilyl cellulose, triethylsilyl cellulose, tri-isopropylsilyl cellulose, tri-n-propylsilyl cellulose, dimethylisopropylsilyl cellulose, diethylisopropylsilyl cellulose, dimethylthexylsilyl cellulose, tert-butyldimethylsilyl cellulose and di-tert-butylmethylsilyl cellulose.

In one embodiment, the silylated cellulose is not a silylated (hydroxypropyl)methyl cellulose based on alkoxysilane.

The silylated cellulose may also be a triarylsilyl cellulose selected from the group of triphenylsilyl cellulose, tribenzylsilyl cellulose, tri-p-xylylsilyl cellulose and tri-p-tolylsilyl cellulose.

The silylated cellulose may also be an alkylarylsilyl cellulose selected from the group of dimethylphenylsilyl cellulose, diphenylmethylsilyl cellulose, di-isopropylphenylsilyl cellulose, isopropyldiphenylsilyl cellulose, tert-butyldiphenylsilyl cellulose and di-tert-butylphenylsilyl cellulose.

Given the non-polar character of the silylated celluloses e.g. as identified above, a sensing composition of the invention is in particular capable of interacting with non-polar analytes. Accordingly, the sensing composition is in particular suitable for the detection of non-polar volatiles. Such volatiles are typically terpenes (hydrocarbons) or terpenoids (terpenes with a functional group such as an oxygen containing functional group). Examples of suitable terpenes and terpenoids are hemiterpenes, hemiterpenoids, monoterpenes, monoterpenoids, sesquiterpenes, sesquiterpenoids, diterpenes and diterpenoids.

In certain embodiments, an alkyl group and/or an aryl group is optionally substituted by one to three moieties independently selected from the group of hydroxy, halo, cyano, —(C1-C6)alkyl, (C1-C6)alkoxy, —(C1-C6)hydroxyalkyl, (C1-C6)alkyl-NH(C═O)—, NH₂(C═O)—, and —(C3-C8)cycloalkyl.

A large range of other materials has been tested as an auxiliary material, including various filter papers and membranes, but these appeared not suitable due to e.g. a lack of sensitivity, the appearance of a strong medium background or the suffering from the humidity from the medium. The only class of materials that yielded a high sensitivity without negative effects due to other components present in the cell culture medium was found to be the silylated cellulose.

The silylation of cellulose typically involves the presence of one, two or three silyl groups on a monomeric sugar unit (two substituted hydroxy groups on the ring and one substituted methylol group on the ring). The average number of substituted hydroxy groups per monomeric unit is termed the “degree of substitution” (or silylation), abbreviated as DS. Usually, the DS is in the range of 1.0-3.0, in particular in the range of 2-2.95, more in particular in the range of 2.5-2.9 and even more in particular in the range of 2.7-2.9.

The fluorescent dye is a specially designed dye that changes its fluorescence intensity (brightness) and/or color in response to a change in its microenvironment polarity, viscosity, and molecular order. Such change occurs due to physical intermolecular interactions between an analyte and the dye (dipole-dipole, dipole-induced dipole, hydrogen-bonding, etc.), which alters the energy difference between the electronic ground and excited states of the dye. For example, the interactions concern a dynamic quenching mechanism known as Forster resonance energy transfer (FRET), which is useful when absorption-based image analysis is applied.

Some fluorescent dyes may require testing of their suitability for a combination with silyl groups for example with silylated cellulose. For example, Koschella and co-workers (Koschella et al; Polymer Bulletin 39 (1997) 597-604) reported that anthracene when used as a label with silylated cellulose is subject to quenching by the silyl substituents.

In a composition of the invention, the fluorescent dye is usually a dye having the property that it undergoes a change in color upon contact with the analyte; a so-called solvatochromic fluorescent dye. Such change in color is usually observable with the naked eye. Quantitative analysis may be performed by image analysis and spectrophotometric analysis such as fluorescence spectroscopy, UV-visible absorbance (colorimetry), phosphorescence, chemiluminescence, infrared absorbance and Raman spectroscopy.

Such solvatochromic dye may be selected from the group of 4-nitrobenzoxadiazole (NBD), Dansyl, 4-[4-(dimethylamino)styryl]-N-methylpyridinium iodide (DASPMI), Prodan, Dapoxyl, 4-dimethylaminopyridine (4-DMAP), 4-amino-1,8-naphthalimide derivatives, azo dyes such as Sudan dyes (e.g. Sudan I and Sudan II), Reichardt's dye, Oil Red O and Nile Red, preferably Oil Red O or Nile Red.

The fluorescent dye may also be a dye having the property that it changes its fluorescence intensity upon contact with the analyte; a so-called fluorogenic dye. While the analyte can either enhance or diminish the dye's fluorescence emission, as long as the modulation is strong, it is preferred that the presence of the analyte enhances the dye's fluorescence emission. This is because diminished fluorescence in the presence of analyte is subject to more interferences. For example, signal decrease can be associated not only with the presence of analyte but also with the loss of dye, degradation of optics, and other factors unrelated to the analyte.

When the composition of the invention is designed to detect a terpenoid, in particular a sesquiterpene, then the fluorescent dye is preferably a lipophilic fluorescent dye, in particular a lipophilic solvatochromic fluorescent dye.

A composition of the invention may be used as such for the detection of a volatile, i.e. the composition is shaped in such form that may contact a volatile that is present a reaction vessel, or that escapes from such vessel. Preferably, however, the composition is present on a support that gives the composition structural integrity and increases the ease of handling the composition.

Accordingly, the invention further relates to a support comprising a layer of the sensing composition as described above, wherein the layer is present on a surface of the support. The support may in principle be any support on which the composition can adhere sufficiently strong. For example, the support comprises a material selected from the group of glass, silicon (in particular a silicon wafer), a polyamide, a polyester (in particular polyethylene terephthalate), and polyolefin (in particular polyethylene or polypropylene). Depending on the application, the support may be rigid or flexible. Further, the support may be transparent or non-transparent to visible light. A transparent support allows measurement of light that is transmitted through the support, which is advantageous since it is less affected by scattering phenomena and provides a better signal to noise ratio.

The composition is provided on the support as a layer. Such layer may be a continuous layer but may also comprise a plurality of areas that are present on one surface of the support. When the support is placed on a multiple well plate, the layer should at least be present on top of the wells; it is not necessary that the layer also extends over surface areas that are present between the wells. Therefore, the sensing composition may be present on the support as a plurality of dots or spots of any suitable shape (“islands”), each of which may be regarded as a layer of sensing composition that is present on the support.

The layer usually has a thickness in the range of 0.01-200 μm, in particular in the range of 0.05-100 μm. It may also be in the range of 0.1-50 μm, in the range of 0.2-10 μm or in the range of 0.5-2 μm. The thickness may be 150 μm or less, 25 μm or less, 5 μm or less, 1 μm or less, or 0.5 μm or less, 0.1 μm or less or 0.05 μm or less. It may be at least 0.01 μm, at least 0.02 μm, at least 0.05 μm, at least 0.1 μm, at least 0.2 μm, at least 0.5 μm, at least 1.0 μm, at least 2.0 μm, at least 5.0 μm, at least 10 μm, at least 20 μm, at least 50 μm, at least 100 μm, or at least 200 μm.

A composition of the invention may comprise a matrix material. Such material is not involved in the actual detection of an analyte but gives a particular structure to the composition. For example, it has an open structure and/or has pores so that transport of the analyte through the material is possible and the actual contact surface area of the composition is increased (more access of the analyte to the luminescent dye). A higher accessibility results in a stronger color change and/or more change in fluorescence intensity.

A matrix material may also be advantageous during the process for providing a sensing composition of the invention on a support. For example, the matrix material may assist in applying the sensing composition (in particular the luminescent dye) in a well-defined (and therefore reproducible) quantity—when the amount of accessible luminescent dye present per unit support surface is quantified, quantitative analyte measurement is easier. Further, a proper matrix material may increase the adhesion of the sensing composition to the support and prevent disruption or detachment from the support during manufacturing and use of the support.

When a matrix material is used in the composition, the layer on the support may be thicker than without a matrix material, for example in the range of 1-100 μm, in particular in the range of 5-50 μm.

If present, the matrix material may comprise a material selected from the group of polystyrene, aromatic epoxy acrylates and methacrylates, aliphatic epoxy acrylates and methacrylates, silicone gels and cellulose derivatives (e.g. nitrocellulose, cellulose acetate and cellulose acetate butyrate).

The invention further relates to a method for preparing a support as described above, comprising
preparing a solution of the silylated cellulose and the fluorescent dye in an organic solvent; then
providing a film of the solution onto a surface of the support; then
allowing the organic solvent to evaporate so that a layer of the sensing composition is formed on the surface of the support.

In case the desired layer comprises a matrix material, then the matrix material is in principle also dissolved in the organic solution prior to applying the film of the solution. By choosing an appropriate matrix material, a layer of sensing composition with a desired porosity is formed upon evaporation.

In a method, support or sensing composition of the invention, the fluorescent dye is preferably selected from the group of 4-nitrobenzoxadiazole (NBD), Dansyl, 4-[4-(dimethylamino)styryl]-N-methylpyridinium iodide (DASPMI), Prodan, Dapoxyl, 4-dimethylaminopyridine (4-DMAP), 4-amino-1,8-naphthalimide derivatives, azo dyes such as Sudan dyes (e.g. Sudan I and Sudan II), Reichardt's dye, Oil Red O and Nile Red, preferably Oil Red O or Nile Red.

The organic solvent is usually selected from the group of chloroform, toluene, tetrahydrofuran, dichloromethane, acetone, butanone, n-hexane and n-pentane.

In a method according the invention, the concentration of the silylated cellulose in the solution prior to spin-coating is in the range of 0.01-10 wt. %, preferably in the range of 0.1-5 wt. %; and/or the concentration of the fluorescent dye in the solution prior to spin-coating is in the range of 0.001-10 wt. %, preferably in the range of 0.01-1 wt. %.

The film of the solution is preferably applied by knife blading, more preferably by spin-coating. It may also be applied by dip-coating or spray coating. It may in particular be applied by means of Langmuir-Blodgett deposition.

The invention has successfully been applied by incubating a support with the sensing composition on wells of a 96-well plate containing either terpenoid standards or cultures of microbial terpenoid-producing strains, resulting in a clearly visible color shift.

Accordingly, the invention further relates to the use of a sensing composition or a support comprising such sensing composition for the detection of a volatile, preferably a hydrophobic volatile, more preferably a volatile terpene or terpenoid. Preferably, such use is in high throughput screening.

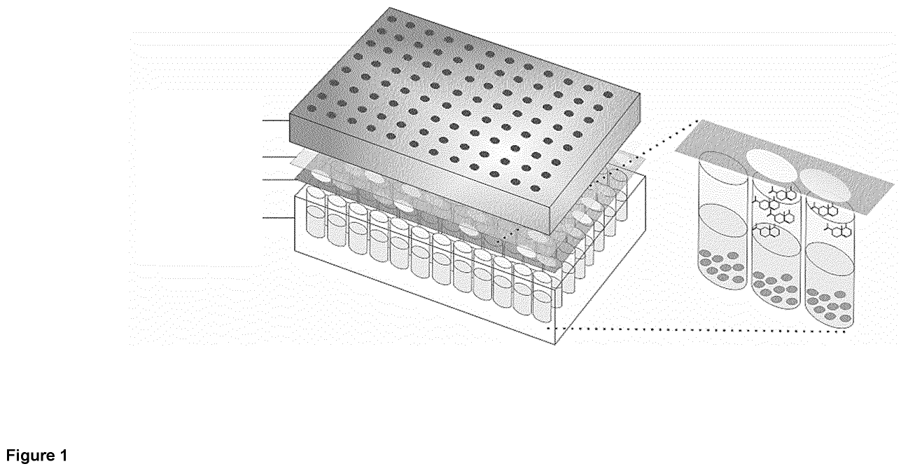

For example, FIG. 1 displays a set-up for screening cultures in a 96-well plate (1), each well comprising a medium (5) with a microbial culture. In an exploded view, the 96-well plate is shown having on top of the wells a sensing composition of the invention. This composition is present as a layer on a support (2) of glass or PET. The support (2) is attached to a sandwich cover (4) with a plastic foil (3) in between. This together forms a kind of lid, which covers all wells at once when it is laid on the 96-well plate (1). It can be seen that the layer on top of the wells has different colors for different wells. This is further demonstrated in a close-up of three wells, which is shown on the right of the exploded view. Each well comprises a medium with a microbial culture. A volatile that is eventually formed in the well is displayed in the atmosphere above the medium as a molecular structure of a terpenoid. On top of each well is a layer of the sensing composition, which is uncolored when no volatile is present (left well), intensely colored when a high amount of volatile is present (middle well) and slightly colored due to a moderate amount of volatile (right well).

The invention further relates to a method for detecting a volatile, the method comprising:
providing a sensing composition or a support comprising such sensing composition as described above;
providing a potential source of a volatile;
placing the sensing composition in the vicinity of the source so that if a volatile is formed, the volatile will reach the sensing composition in an amount that is sufficient for detecting the volatile;
analyzing the sensing composition to determine whether a volatile of the potential source has reached the sensing composition (and is thus present in or on the sensing composition); and
optionally quantifying the amount of the detected volatile, by spectrophotometric analysis, in particular by measurement of the fluorescence and the UV-visible absorbance, and/or by image analysis of the sensing composition, in particular of the layer of the sensing composition that is present in case a support is used in the detection method.
   In the case of image analysis, the analysis is typically performed on a layer of the sensing composition that is present on a support.
Usually, the potential source is a cell culture comprising cells that are (likely) capable of producing a volatile. For example, the cell culture is capable of producing a terpene or terpenoid, in particular sesquiterpene or sesquiterpenoid.
Preferably, the method is for high throughput screening of cell cultures on the production of a volatile, preferably a hydrophobic volatile, more preferably a volatile terpenoid.

### Further Embodiments

1. Sensing composition for detecting a volatile organic compound in its gas phase, comprising
a silylated cellulose selected from the group of trialkylsilyl cellulose, triarylsilyl cellulose and alkylarylsilyl cellulose; and
a fluorescent dye.

2. Sensing composition according to embodiment 1, wherein the silylated cellulose is a trialkylsilyl cellulose selected from the group of trimethylsilyl cellulose, triethylsilyl cellulose, tri-isopropylsilyl cellulose, tri-n-propylsilyl cellulose, dimethylisopropylsilyl cellulose, diethylisopropylsilyl cellulose, dimethylthexylsilyl cellulose, tert-butyldimethylsilyl cellulose and di-tert-butylmethylsilyl cellulose.

3. Sensing composition according to embodiment 1, wherein the silylated cellulose is an alkylarylsilyl cellulose selected from the group of dimethylphenylsilyl cellulose, diphenylmethylsilyl cellulose, di-isopropylphenylsilyl cellulose, isopropyldiphenylsilyl cellulose, tert-butyldiphenylsilyl cellulose and di-tert-butylphenylsilyl cellulose.

4. Sensing composition according to any of embodiments 1-3, wherein the fluorescent dye is a solvatochromic dye, preferably a lipophilic solvatochromic dye.

5. Sensing composition according to any of embodiments 1-4, wherein the fluorescent dye is selected from the group of 4-nitrobenzoxadiazole (NBD), Dansyl, 4-[4-(dimethylamino)styryl]-N-methylpyridinium iodide (DASPMI), Prodan, Dapoxyl, 4-dimethylaminopyridine (4-DMAP), 4-amino-1,8-naphthalimide derivatives, azo dyes such as Sudan dyes (e.g. Sudan I and Sudan II), Reichardt's dye, Oil Red O and Nile Red.

6. Support comprising a layer of the sensing composition according to any one of embodiments 1-5, wherein the layer is present on a surface of the support.

7. Support according to embodiment 6, wherein the support comprises a material selected from the group of glass, silicon, a polyamide, a polyester (in particular polyethylene terephthalate), and polyolefin (in particular polyethylene or polypropylene).

8. Support according to embodiment 6 or 7, wherein the layer has a thickness in the range of 0.05-1 μm.

9. Method for preparing a support according to any of embodiments 6-8, comprising
preparing a solution of the silylated cellulose and the fluorescent dye in an organic solvent; then
preparing a film of the solution onto a surface of the support; then
allowing the organic solvent to evaporate so that a layer of the sensing composition is formed on the surface of the support.

10. Method according to embodiment 9, wherein
the concentration of the silylated cellulose in the solution prior to spin-coating is in the range of 0.01-10 wt. %, preferably in the range of 0.1-5 wt. %; and/or
the concentration of the fluorescent dye in the solution prior to spin-coating is in the range of 0.001-10 wt. %, preferably in the range of 0.01-1 wt. %.

11. Use of a sensing composition according to any one of embodiments 1-5 or a support according to any one of embodiments 6-8 for detecting a volatile, preferably a hydrophobic volatile, more preferably a volatile terpenoid.

12. Use according to embodiment 11 in high throughput screening.

13. Method for detecting a volatile, the method comprising:
providing a sensing composition according to any one of embodiments 1-5, or a support according to any one of embodiments 6-8;
providing a potential source of a volatile;
placing the sensing composition in the vicinity of the source so that if a volatile is formed, the volatile will reach the sensing composition in an amount that is sufficient for detecting the volatile;
analyzing the sensing composition to determine whether a volatile of the potential source has reached the sensing composition; and
optionally quantifying the amount of the detected volatile, by spectrophotometric analysis, and/or by image analysis of the sensing composition.

14. Method according to embodiment 13, wherein the potential source is a cell culture comprising cells that are able to produce a volatile.

15. Method according to embodiments 13 or 14, wherein the method is for high throughput screening of cell cultures on the production of a volatile, preferably a hydrophobic volatile, more preferably a volatile terpenoid.

### EXAMPLES

### General considerations

Standard laboratory reagents were purchased from Carl Roth GmbH & Co. KG, Karlsruhe, Germany. Gistex® Yeast extract was obtained from DSM Food Specialties B.V., AX Delft, The Netherlands. Manganese(II) sulfate monohydrate, Nickel(II) sulfate hexahydrate and Neomycin trisulfate salt hydrate were purchased from Sigma-Aldrich®, Vienna, Austria. Zeocin™ was bought from InvivoGen, (Vienna, Austria). Yeast extract, peptone and Difco™ yeast nitrogen base w/o amino acids were obtained from Becton, Dickinson and Company, Schwechat, Austria. Sterile water was acquired from Fresenius Kabi, Graz, Austria. (+)-Valencene reference standard was supplied by Isobionics B.V., Geleen, The Netherlands. Trimethylsilyl-cellulose (TMSC; DS: 2.7-2.9) obtained from Avicel pulp, purchased from TITK Rudolstadt MFSA, and Nile-Red (Sigma Aldrich) were used as starting materials for film preparation. Chloroform (99%), methylene chloride (99%), acetone (99%), butanone (99%) and sulfuric acid (95%) were purchased from VWR chemicals; n-dodecane was obtained from VWR International, Vienna, Austria. Hydrogen peroxide (30%) was purchased from Sigma-Aldrich. All chemicals were used without purification. For the filtration Chromafil® Xtra PVDF-45/25 0.45 μm syringe filters were used.

### Example 1: Preparation of a Support with the Sensing Composition Comprising Trimethylsilyl Cellulose (TMSC) and Nile Red as Fluorescent Dye on a Glass Support

The glass support (7.3×10 cm) was first rinsed in a pre-cleaning step with methylene chloride, acetone and water. Afterwards, the support was placed into “piranha” acid (H₂SO₄(95%):H₂O₂(30%)=7:3 (v/v)) for 30 min to remove organic residues, and was then neutralized with distilled water. For preparation of the sensing composition, trimethylsilyl-cellulose (TMSC; DS: 2.8-3.0) and Nile Red were dissolved in an organic solvent, e.g. chloroform, toluene, tetrahydrofuran, dichloromethane, acetone, butanone, and were filtered (pore size: 0.45-3 μm). Thereafter, the solution was spin-coated onto the glass support after which the solvent was allowed to evaporate. The obtained layer thickness was 20 nm-3 μm; this was dependent on the concentration of TMSC (0.1-5 wt. %) and Nile-Red (0.01-1 wt. %) in the solvent, on the volume of TMSC solution (3-12 ml) and on the parameters of the spin coating (speed: 500-7000 rpm; acceleration: 100-4000 rpm/s; time: 10-300 s).

### Example 2: Stylus Profilometry/Determination of Film Thickness

To measure layer thickness a DEKTAK 150 Stylus Profiler from Veeco (Veeco Instruments Inc., Plainview, N.Y. 11803, USA; instrument now available from Bruker Corporation, Billerica, Mass. 01821, USA) was used. The scan length was set to 1000 μm, measurements lasting for 3 s. The diamond stylus had a radius of 12.5 μm. The force was 3 mg with a resolution of 0.333 μm/sample and a measurement range of 6.5 μm. The profile was set to Hills and Valleys.

For determination the sample was scratched five times up to the glass surface. This measured profile was then used to calculate the thickness of the layer.

### Example 3: Preparation of a Support with the Sensing Composition Comprising Trimethylsilyl Cellulose (TMSC) and Oil Red O as Fluorescent Dye on a Glass Support

The glass support (7.3×10 cm) was first rinsed in a pre-cleaning step with methylene chloride, acetone and water. Afterwards, the support was placed into “piranha” acid (H₂SO₄(95%):H₂O₂(30%)=7:3 (v/v)) for 30 min. to remove organic residues, and was then neutralized with distilled water. For preparation of the sensing composition, trimethylsilyl-cellulose (TMSC; DS: 2.8-3.0, 1 wt. % in respect to the solvent) and Oil Red O (0.2 wt. % in respect to the solvent) were dissolved in chloroform, and were filtered (pore size: 0.45-3 μm) before spin coating (v=4000 rpm; a=2500 rpm/s; t=60 s) onto the glass support. The obtained layer thickness after evaporation of the solvent was 275-300 nm.

### Example 4: Preparation of a Support with the Sensing Composition Comprising Trimethylsilyl Cellulose (TMSC) and Nile Red as Fluorescent Dye on a PET Support

A PET support (7.3×10 cm) was cleaned with isopropanol in an ultrasonic bath for 10 min. After drying the PET support was attached on a glass plate with the same size using a double-faced adhesive foil. For the film preparation, TMSC (DS 2.8-3) was dissolved in chloroform to a concentration of 2 wt. % in respect to the solvent. After filtration through a PVDF Syringe filter (0.45 μm mesh size), Nile red was added to a concentration of 0.2 wt. % in respect to the solvent. Spin coating of the solution onto the PET support attached on glass plate and evaporation of the solvent led to uniform layers with a thickness of 275-325 nm. (Speed: 4000 rpm, acceleration: 2500 rpm.s⁻¹, duration: 60 s).

TABLE 1
Responses obtained with the TMSC/Nile Red layer

| Compound | Incubation conditions | Response |
|---|---|---|
| Aqua bidestilled “Fresenius” (H₂O) | 200 μl H₂O | − |
| Fresenius Kabi Austria | | |
| trans-Cinnamaldehyde Purity: 99% | 200 μl H₂O + 25 μl | ++ |
| Sigma Aldrich (C80687) | Compound | |
| Cinnamyl alcohol Purity: 98% | 200 μl H₂O + 25 μl | ++ |
| Sigma Aldrich (108197) | Compound | |
| Valencene Purity: 70% | 200 μl H₂O + 5 μl | +++ |
| Isobionics | Compound | |
| cis-Nootkatol Purity: 98% | 200 μl H₂O + 5 μl | − |
| Isobionics | Solution (dissolved | |
| | in Ethanol absolute; | |
| | 3.05M) | |
| Nootkatone Purity: 70-80% | 200 μl H₂O + 10 μl | + |
| Isobionics | Compound | |
| (E)-Nerolidol Purity: 97.2% | 200 μl H₂O + 5 μl | +++ |
| DSM Nutritional Products (LJ | Compound | |
| 32808B049) | | |
| (1R,2S,5R)-(−)-Menthol Purity: | 200 μl H₂O + 5 μl | +++ |
| >99% | Solution (dissolved | |
| DSM Nutritional Products (Fluka | in Ethanol absolute; | |
| 63660) | 1.66M) | |
| Farnesol Purity: ≥95% | 200 μl H₂O + 5 μl | + |
| Sigma Aldrich (43348) | Compound | |
| (E)-β-Farnesene Purity: — | 200 μl H₂O + 5 μl | +++ |
| Bedoukian Research | Compound | |
| Methanol Purity: 99.9% | 200 μl Compound | +++ |
| Carl Roth (7342.1) | | |
| (1S)-(−)-β-Pinene | 200 μl H₂O + 5 μl | +++ |
| Purity: — | Compound | |
| (S)-(+)-Carvone Purity: 96% | 200 μl H₂O + 5 μl | +++ |
| Sigma Aldrich (435759) | Compound | |
| Linalool Purity: 97% | 200 μl H₂O + 5 μl | +++ |
| Acros Organics (125151000) | Compound | |
| Myrcene Purity: ≥90% | 200 μl H₂O + 5 μl | +++ |
| Sigma Aldrich (W276200) | Compound | |
| Piperonal Purity: 99% | 200 μl H₂O + 25 μl | ++ |
| Sigma Aldrich (P49104) | Solution (in absolute | |
| | ethanol; 0.75M) | |
| (S)-(−)-Limonene Purity: 96% | 200 μl H₂O + 5 μl | +++ |
| Sigma Aldrich (218367) | Compound | |

### Example 5: Detection of Lipophilic Volatile Compounds on a TMSC/Nile Red layer

Ninety-six-half-deep-well microtiter plates were filled with different volatile compounds (aldehydes, alcohols, mono- and sesquiterpenoids). Evaporation was improved by addition of water—creating a biphasic system. The response of every substance on the layer was measured in triplicates (Table 1). General incubation conditions in the shaker were 28° C., 320 rpm for 1 h. Since the compounds are highly volatile, repetitive layer developments were performed by applying only two columns of volatile compounds in each round to avoid premature evaporation. Cis-Nootkatol showed instant crystallization upon contact with water, thus no volatile compound was emitted under the conditions of the experiment. Correspondingly, the layer of sensing composition did not reveal the presence of this compound.

### Example 6: Cultivation of Terpenoid-Producing Cultures in Deep Well Plates (DWPs) and Detection and Quantification of Valencene Produced by Microbial Culture of Rhodobacter Sphaeroides on a Glass Support Comprising TMSC and Nile Red

Rhodobacter strains were routinely cultivated in RS102 medium (20 g/L yeast extract, 0.5 g/L NaCl, 0.5 g/L MgSO₄.7H₂O, 33 g/L dextrose monohydrate, 0.16 g/L (NH₄)₂Fe(SO₄)₂.6H₂O, 12 mg/L ZnSO₄.7H₂O, 4 mg/L MnSO₄.H₂O, 0.4 mg/L NiSO₄.6H₂O, 4 mg/L vitamin C, 0.15 g/L CaCl₂.2H₂O, 10 mg/L FeCl₃.6H₂O, 7.5 μL/L HCl (37%), pH 7.4) with 100 mg/L Neomycin. Precultures were grown in 96-DWPs containing 300 μL of RS102 for 60-72 h at 28° C. and 320 rpm (50 mm orbit). Main cultures were started in 96-DWPs, inoculating 390 μL of RS102 with 10 μL of preculture. The DWPs were covered with a sandwich cover specifically designed to reduce evaporation (Enzyscreen B.V., ER Haarlem, The Netherlands). Following 29 h of cultivation at 28° C. and 320 rpm (50 mm orbit), the glass plate carrying the spin-coated TMSC-NR layer—pre-heated for 45 min at 60° C. to remove any humidity—was placed on the DWP and cultivation was continued for 5 h. Thereafter, the layer was removed from the DWP and scanned using a HP Scanjet 4370 flatbed scanner, upon placing a plastic foil in between the layer and the scanner to avoid interference patterns. Densitometric analysis of the scan was performed utilizing the image processing program ImageJ distributed by Fiji (Schindelin et al., 2012) and the Plugin MicroArray Profile (http://www.optinay.com/MicroArray_Profile.htm). Alternatively, the layer can be evaluated using fluorescence analysis. For this purpose, the layer is placed on a frame and put in a microplate reader with excitation filter set at 544 nm and emission filter set at 590 nm. Measurement was performed with 10 flashes per well in a diameter of 4 mm.

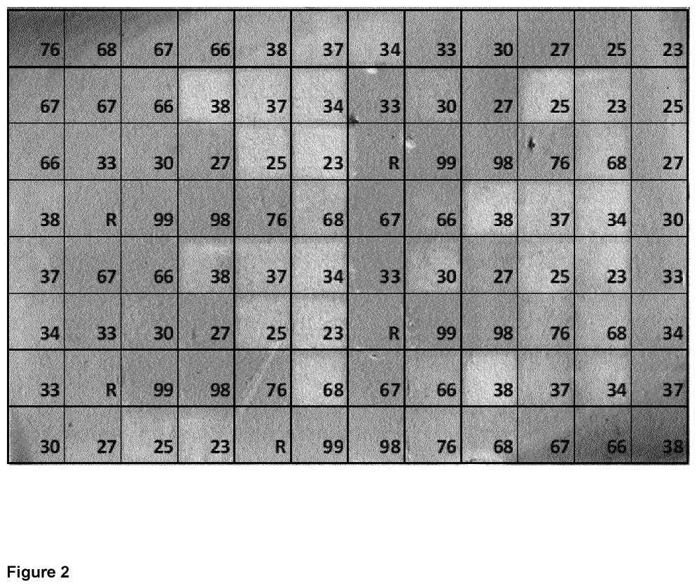

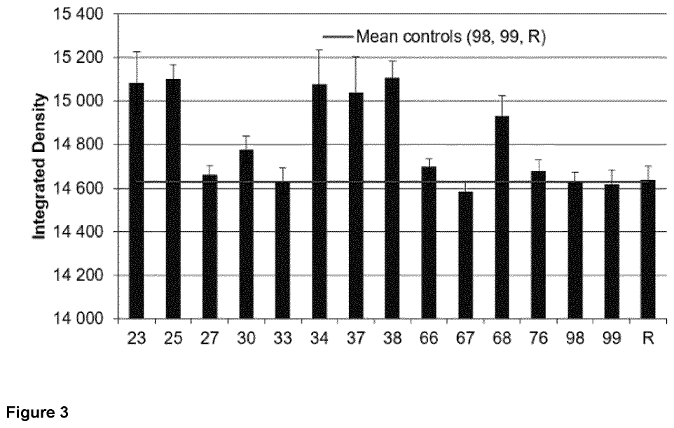

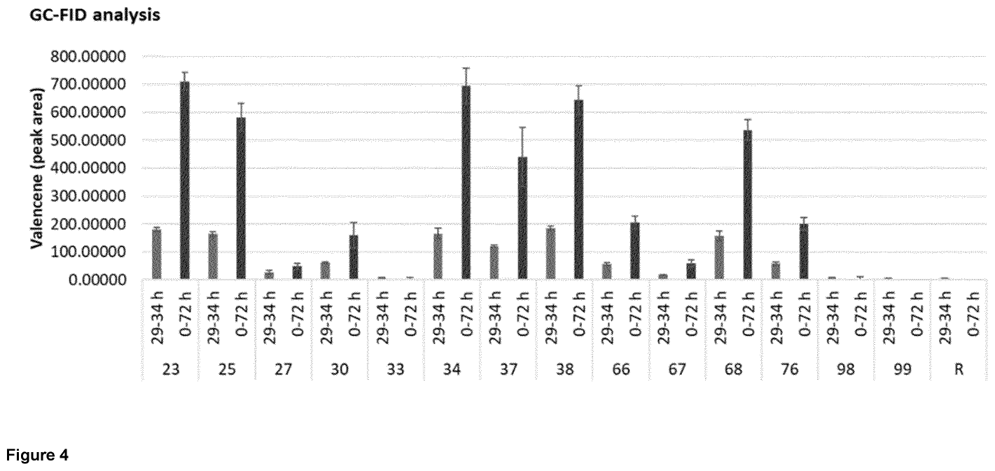

For validation of the screening procedure, “calibration” strains, that is different R. sphaeroides strains producing various levels of (+)-valencene, were tested. In order to identify the optimal time range for terpenoid detection that would be representative for the actual production capacities, the strains were cultivated with 20 vol % n-dodecane and aliquots were withdrawn for GC-FID analysis (Gas Chromatography—Flame Ionization Detector) at defined time points. For validation of the chosen time frame of 29 to 34 h after start of cultivation, parallel DWP cultivations for screening and GC-FID analysis were performed. One DWP was cultivated with dodecane for 72 h to determine the total level of valencene production by different strains. Further, two DWPs were cultivated for 29 h. Subsequently, n-dodecane was added to the first plate while a glass plate with a TMSC-NR layer was placed on the second plate. Cultivation of these two plates was continued for five hours. FIG. 2 shows a scan of a support with a layer of a sensing composition of the invention containing 0.05% Nile Red after incubation for the 5 hours on the 96-well plate with cultivated R. sphaeroides strains. FIG. 3 displays a densitometric analysis of the scan of the TMSC film containing 0.05% Nile Red using the program ImageJ (the 60 inner wells were used for evaluation). FIG. 4 displays the results of the GC-FID analysis of the different strains of the cultivated R. sphaeroides. The different strains represent the valencene production levels from 29 to 34 h after start as well as during the entire 72 h of cultivation.

The strains that gave the highest responses in the screening were the same strains that also produced the highest levels of valencene, both between 29 and 34 h as well as after 72 h of cultivation. These results confirm that the TMSC-NR layer set-up is suitable to screen R. sphaeroides strains for their valencene production levels.

### Example 7: Screening a Library of Randomly Mutagenized Valencene Synthase Variants in R. sphaeroides for Improved Valencene Titers

Mutagenic PCR was performed with the “GeneMorph II Random Mutagenesis Kit” (Agilent Technologies) using the sequence of the so far best valencene synthase variant as template. Cultivation and screening of the library was performed as follows:

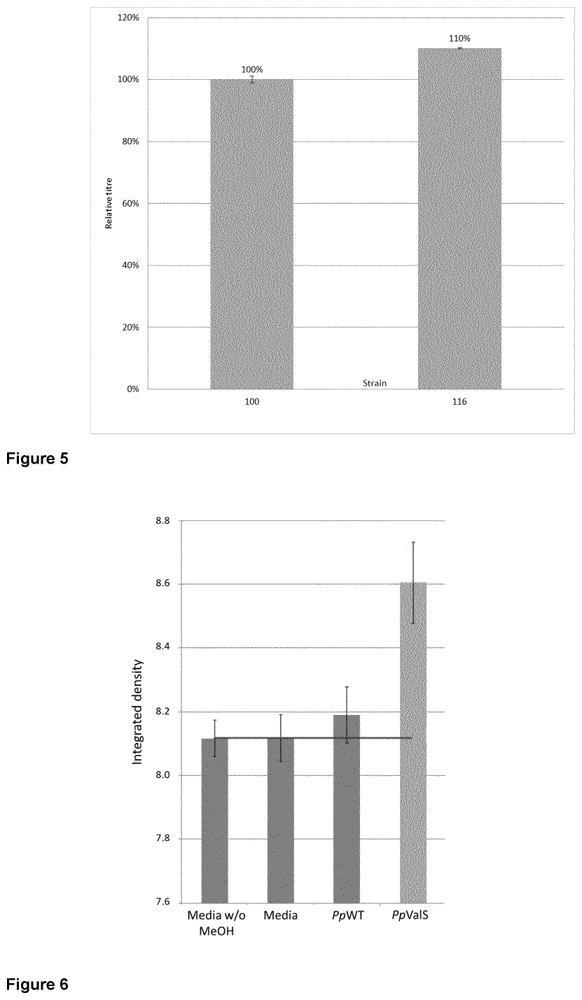

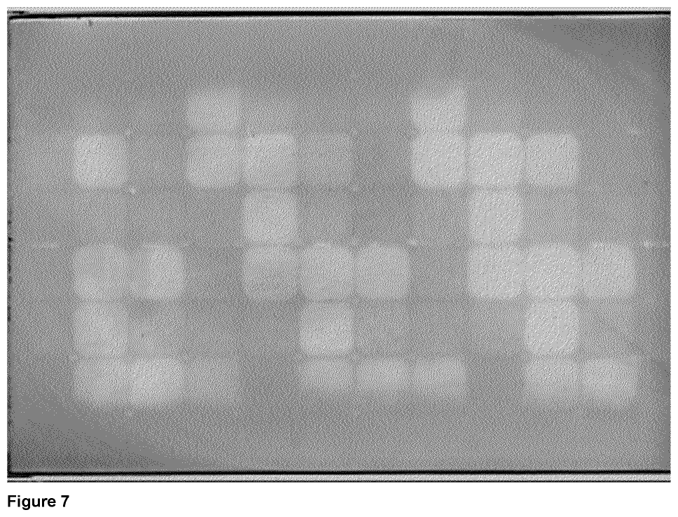

Precultures were grown as described in example 6. Main cultures were started in half-high 96-DWPs (Enzyscreen B.V., ER Haarlem, The Netherlands), inoculating 140 μL of RS102 with preculture using a pin-stamp. Cultivation time was reduced to 18 h. The layer was placed on the half-high DWP and cultivation was continued for 70 min (glass support) or 2 h 30 min (PET support). A strain that showed improved valencene titers in the screening was then evaluated using biphasic cultivation with n-dodecane and subsequent GC-FID analysis. For example, FIG. 5 displays the GC-FID analysis of valencene levels in n-dodecane phase after cultivation of back-ground strain #100 and improved strain #116 identified during screening.

### Example 8: Detection of Valencene Produced by Microbial Culture of a Pichia pastoris Strain on a Glass Support Comprising TMSC/Nile Red

A Pichia pastoris strain expressing a codon-optimized Valencene synthase from Callitropsis nootkatensis controlled by the methanol-inducible AOX1 promoter was used—previously described in Wriessnegger et al. (2014). Strains were grown in 96-DWPs containing 250 μL of buffered complex glycerol medium, BMGY (1% yeast extract, 2% peptone, 100 mM potassium phosphate, pH 6.0, 1.34% YNB, 4×10-5% biotin, 1% glycerol) for 48 h at 28° C. and 320 rpm. For induction, 250 μl of BMMY (1% yeast extract, 2% peptone, 100 mM potassium phosphate, pH 6.0, 1.34% YNB, 4×10⁻⁵% biotin, 2% methanol) were added and cultivation was continued. Twelve hours after the first induction, 50 μl of BMMY (10% MeOH) were added. Two hours after the second induction, the glass plate carrying the spin-coated TMSC-NR layer was placed on the DWP and cultivation was continued for 5 h. Then, the layer was evaluated using ImageJ. FIG. 6 displays the results for wells with P. pastoris wild type (PpWT) and valencene synthase-expressing (PpValS) strains. As negative controls, the results for wells containing medium only are shown.

### REFERENCES

Gounaris, Y., 2010. Biotechnology for the production of essential oils, flavours and volatile isolates. A review. Flavour Fragr. J. 25, 367-386. https://doi.org10.1002/ffj.1996

Hunter, G. L. K., Brogden, W. B., 1965. Terpenes and Sesquiterpenes in Cold-pressed Orange Oil. Journal of Food Science 30, 1-4. https://doi.org/10.1111/j.1365-2621.1965.tb00252.x

Wilson, C. W., Shaw, P. E., 1978. Synthesis of nootkatone from valencene. Journal of Agricultural and Food Chemistry 26, 1430-1432. https://doi.org/10.1021/jf60220a054

Girhard, M., Machida, K., Itoh, M., Schmid, R. D., Arisawa, A., Urlacher, V. B., 2009. Regioselective biooxidation of (+)-valencene by recombinant E. coli expressing CYP109B1 from Bacillus subtilis in a two-liquid-phase system. Microbial Cell Factories 8, 36. https://doi.org/10.1186/1475-2859-8-36

Beekwilder, J., van Houwelingen, A., Cankar, K., van Dijk, A. D. J., de Jong, R. M., Stoopen, G., Bouwmeester, H., Achkar, J., Sonke, T., Bosch, D., 2014. Valencene synthase from the heart-wood of Nootka cypress (Callitropsis nootkatensis) for biotechnological production of valencene. Plant Biotechnol. J. 12, 174-182. https://doi.org/1111/pbi.12124

Wriessnegger, T., Augustin, P., Engleder, M., Leitner, E., Muller, M., Kaluzna, I., Schërmann, M., Mink, D., Zellnig, G., Schwab, H., Pichler, H., 2014. Production of the sesquiterpenoid (+)-nootkatone by metabolic engineering of Pichia pastoris. Metabolic Engineering 24,18-29. https://doi.org/10.1016/j.ymben.2014.04.001

Lang, H. P., Cogdell, R. J., Takaichi, S., Hunter, C. N., 1995. Complete DNA sequence, specific Tn5 insertion map, and gene assignment of the carotenoid biosynthesis pathway of Rhodobacter sphaeroides. Journal of bacteriology 177, 2064-2073.

Ubersax, J., Frenz, L., 2012. Methods and compositions for detecting microbial production of water-immiscible compounds. WO2012/158466.

Furubayashi, M., Ikezumi, M., Kajiwara, J., Iwasaki, M., Fujii, A., Li, L., Saito, K., Umeno, D., 2014. A High-Throughput Colorimetric Screening Assay for Terpene Synthase Activity Based on Substrate Consumption. PLoS ONE 9, e93317. https://doi.org/10.1371/journal.pone.0093317

Withers, S. T., Gottlieb, S. S., Lieu, B., Newman, J. D., Keasling, J. D., 2007. Identification of Isopentenol Biosynthetic Genes from Bacillus subtilis by a Screening Method Based on Isoprenoid Precursor Toxicity. Applied and Environmental Microbiology 73,6277-6283. https://doi.org/10.1128/AEM.00861-07

Kirby, J., Nishimoto, M., Chow, R. W. N., Pasumarthi, V. N., Chan, R., Chan, L. J. G., Petzold, C. J., Keasling, J. D., 2014. Use of Nonionic Surfactants for Improvement of Terpene Production in Saccharomyces cerevisiae. Applied and Environmental Microbiology 80, 6685-6693. https://doi.org/10.1128/AEM.02155-14

Lauchli, R., Rabe, K. S., Kalbarczyk, K. Z., Tata, A., Heel, T., Kitto, R. Z., Arnold, F. H., 2013. High-Throughput Screening for Terpene-Synthase-Cyclization Activity and Directed Evolution of a Terpene Synthase. Angewandte Chemie International Edition 52, 5571-5574. https://doi.org/10.1002/anie.201301362

Vardakou, M., Salmon, M., Faraldos, J. A., O'Maille, P. E., 2014. Comparative analysis and validation of the malachite green assay for the high throughput biochemical characterization of terpene synthases. MethodsX 1, 187-196. https://doi.org/10.10161j.mex.2014.08.007

Lagares Jr., A., Valverde, C., 2017. Quantification of Bacterial Polyhydroxybutyrate Content by Flow Cytometry. BIO-PROTOCOL 7. https://doi.org/10.21769/BioProtoc.2638

Zayed et al.; Int. Journal of Pharmaceutics 532 (2017); Microgels of silylated HPMC as a multi-modal system for drug co-encapsulation, 790-801

Koschella et al.; Polymer Bulletin 39 (1997) New fluorescence active cellulosics prepared by a convenient acylation reaction, 597-604

1.-15. (canceled)

16. A method for detecting a volatile, the method comprising:
providing a sensing composition for detecting a volatile comprising a silylated cellulose selected from the group consisting of trialkylsilyl cellulose, triarylsilyl cellulose and alkylarylsilyl cellulose; and a fluorescent dye;
providing a potential source of a volatile;
placing the sensing composition in the vicinity of the source so that if a volatile is formed, the volatile will reach the sensing composition in an amount that is sufficient for detecting the volatile;
analyzing the sensing composition to determine whether a volatile of the potential source has reached the sensing composition; and
optionally quantifying the amount of the detected volatile, by spectrophotometric analysis, and/or by image analysis of the sensing composition.

17. The method according to claim 16, wherein the potential source is a cell culture comprising cells that are able to produce a volatile.

18. The method according to claim 16, wherein the method is for high throughput screening of cell cultures on the production of a volatile.

19. A support comprising a layer of a sensing composition for detecting a volatile organic compound in its gas phase, wherein the sensing composition comprises a silylated cellulose selected from the group of trialkylsilyl cellulose, triarylsilyl cellulose and alkylarylsilyl cellulose; and a fluorescent dye., and wherein the layer is present on a surface of the support.

20. The support according to claim 19, wherein the support comprises a material selected from the group consisting of glass, silicon, a polyamide, a polyester, and polyolefin.

21. The support according to claim 19, wherein the layer has a thickness in the range of 0.05-1 μm.

22. A method for preparing the support according to claim 19, comprising
preparing a solution of the silylated cellulose and the fluorescent dye in an organic solvent; then
preparing a film of the solution onto a surface of the support; then
allowing the organic solvent to evaporate so that a layer of the sensing composition is formed on the surface of the support.

23. The method according to claim 22, wherein
the concentration of the silylated cellulose in the solution prior to spin-coating is in the range of 0.01-10 wt. %; and/or
the concentration of the fluorescent dye in the solution prior to spin-coating is in the range of 0.001-10 wt. %.

24. The method according to claim 16, wherein the sensing composition is comprised in a support comprising a layer of a sensing composition for detecting a volatile organic compound in its gas phase, wherein the sensing composition comprises a silylated cellulose selected from the group of trialkylsilyl cellulose, triarylsilyl cellulose and alkylarylsilyl cellulose; and a fluorescent dye, and wherein the layer is present on a surface of the support.

25. The method according to claim 16 wherein the silylated cellulose is a trialkylsilyl cellulose selected from the group of trimethylsilyl cellulose, triethylsilyl cellulose, tri-isopropylsilyl cellulose, tri-n-propylsilyl cellulose, dimethylisopropylsilyl cellulose, diethylisopropylsilyl cellulose, dimethylthexylsilyl cellulose, tert-butyldimethylsilyl cellulose and di-tert-butylmethylsilyl cellulose.

26. A sensing composition for detecting a volatile organic compound in its gas phase, comprising
a silylated cellulose selected from the group consisting of trialkylsilyl cellulose, triarylsilyl cellulose and alkylarylsilyl cellulose; and
a fluorescent dye,
wherein the silylated cellulose is an alkylarylsilyl cellulose selected from the group consisting of of dimethylphenylsilyl cellulose, diphenylmethylsilyl cellulose, di-isopropylphenylsilyl cellulose, isopropyldiphenylsilyl cellulose, tert-butyldiphenylsilyl cellulose and di-tert-butylphenylsilyl cellulose.

27. The sensing composition according to claim 26, used in a method for detecting a volatile, the method comprising:
providing a sensing composition for detecting a volatile comprising a silylated cellulose selected from the group consisting of trialkylsilyl cellulose, triarylsilyl cellulose and alkylarylsilyl cellulose; and a fluorescent dye;
providing a potential source of a volatile;
placing the sensing composition in the vicinity of the source so that if a volatile is formed, the volatile will reach the sensing composition in an amount that is sufficient for detecting the volatile;
analyzing the sensing composition to determine whether a volatile of the potential source has reached the sensing composition; and
optionally quantifying the amount of the detected volatile, by spectrophotometric analysis, and/or by image analysis of the sensing composition.

28. The sensing composition according to claim 26, wherein the fluorescent dye is selected from the group consisting of 4-nitrobenzoxadiazole (NBD), Dansyl, 4-[4-(dimethylamino)styryl]-N-methylpyridinium iodide (DASPMI), Prodan, Dapoxyl, 4-dimethylaminopyridine (4-DMAP), 4-amino-1,8-naphthalimide derivatives, azo dyes such as Sudan dyes (e.g. Sudan I and Sudan II), Reichardt's dye, Oil Red O and Nile Red.

29. Use of a sensing composition according to claim 26 for detecting a volatile.

30. Use of a support according to claim 19 for detecting a volatile.

31. Use according to claim 29 in high throughput screening.

32. The method according to claim 16, wherein the method is for high throughput screening of cell cultures on the production of a volatile terpenoid.

33. The method according to claim 22, wherein
the concentration of the silylated cellulose in the solution prior to spin-coating is in the range of 0.1-5 wt. %; and/or the concentration of the fluorescent dye in the solution prior to spin-coating is in the range of 0.01-1 wt. %.
